(19) United States
(12) Patent Application Publication
(10) Pub. No.: US 2011/0248934 A1
(43) Pub. Date: Oct. 13, 2011

(54) CONTACTLESS TOUCH PANEL

(75) Inventors: Yu-Chou Yeh, Taoyuan County (TW); Min-Hui Chiang, Taoyuan County (TW)

(73) Assignee: J TOUCH CORPORATION, Taoyuan County (TW)

(21) Appl. No.: 12/793,847

(22) Filed: Jun. 4, 2010

(30) Foreign Application Priority Data
Apr. 10, 2010 (TW) 099111050

(51) Int. Cl. G06F 3/041

(52) U.S. Cl. 345/173

(57) ABSTRACT

A contactless touch panel comprises a first transparent substrate, a plurality of planar (or miniaturized) microsensors dispersedly arranged on a surface of the first transparent substrate, a second transparent substrate stacked on the first transparent substrate to cover the microsensors, and a detecting element electrically connected to the microsensors. Thus, when a touching object approaches (does not touch) the touch panel, the microsensors sense the touching object via an electric field or a magnetic field and generate sensing signals sent to the detecting element according to changes in the electric field or the magnetic field and their strength. The detecting element determines a position of the touching object above the touch panel to achieve the purpose of non-contact control.

### BACKGROUND OF THE INVENTION

1. Field of the Invention

The present invention relates to a touch panel, and more particularly to a contactless touch panel for performing the touch-control operation with no need for contact with the touch panel.

2. Description of the Related Art

Referring to FIG. 1, there is shown a schematic view of a conventional contactless touch panel. A plurality of sensors 11 are disposed on the periphery of the touch panel 1. Principally, the sensors 11 are three-dimensional sensors and scan the surface of the touch panel 1 mainly by infrared rays, lasers, ultrasonic waves, or the like. When a touching object approaches the touch panel 1, it can determine a position of the touching object above the surface of the touch panel 1 according to the positions where the signal is interrupted and returned, and the strength of the returned signal, etc.

However, when such three-dimensional sensors 11 are assembled to the touch panel 1, it requires additional design of the connection positions, or when assembled with other electronic devices such as circuit boards, frames, or electronic device shells, it is necessary to design joint spaces or structures corresponding to the volumes, sizes, quantities and locations of the sensors 11. This leads to an increase in the production cost of the entire touch panel 1.

Furthermore, the sensors 11 are additional devices to the touch panel 1. Compared with a capacitive or resistive touch panel, the capacitive or resistive touch panel cannot achieve non-contact control, but their fabrication processes are the same and require no additional connection or assembly.

In addition, a capacitive induction device as disclosed in R.O.C. patent publication No. 200611287 comprises an insulation substrate and a plurality of capacitive induction elements. The capacitive induction elements are spacedly formed in a matrix on the insulation substrate. Each of the capacitive induction elements comprises a first electrode and a second electrode. The second electrodes spacedly surround the first electrodes at an equal distance from the first electrodes. An equivalent capacitance is formed between the first and second electrodes. This patent discloses concentric capacitive induction elements, but according to the capacitive touch panel architecture, the capacitive induction elements are in fact the sensing electrodes (or referred to as an electrode totem) in the capacitive touch panel. The purpose is that the capacitive induction elements can be charged to generate uniform potentials when the capacitive touch panel generates capacitances so as to avoid an erroneous judgment or incorrect operation due to different basic charge potentials when each capacitive induction element is in action. However, it cannot achieve non-contact touch sensing.

Moreover, as disclosed in R.O.C. patent publication No. I300529, entitled “Proximity sensing device and sensing method thereof”, the sensing method is used for judging whether an operation is a correct operation and the proximity sensing device comprises a first sensing area and a second sensing area. The first sensing area is used for sensing the operation and generating a first signal, and the second sensing area is used for sensing the operation and generating a second signal. If a ratio of the first signal and the second signal is greater than a threshold, the operation is judged as a correct operation. In this patent, multiple proximity sensing devices are provided for sensing the operation, but during the sensing process, the judgment of whether a touch operation is correct or not must be performed only by comparison between multiple sensing areas, mainly by comparison between the signals from the first sensing area and the second sensing area, and the touch position cannot be judged directly by external circuits, even though each of the proximity sensing devices operates independently of the others. Intrinsically, this patent can also be categorized into the area of capacitive touch panel technology and the area of single point touch technology. Therefore, it cannot achieve non-contact touch sensing.

Moreover, as disclosed in U.S. patent publication No. 20020190964, entitled “Object sensing”, display components and electric field sensing components are provided on a substrate. Also described is a sensing circuit for detecting current induced in a receiving electrode of an electric field sensing arrangement, wherein the sensing circuit employs two-phase charge accumulation. In operation, two effective circuit parts are selected alternately according to the phase of a voltage concurrently causing electric field emission. Plural thin film electric field sensing circuits and electrodes may be arrayed to provide an object sensing array, usable as an input device. Intrinsically, this patent can also be categorized into the area of capacitive touch panel technology and the area of single point touch technology. Therefore, it cannot achieve non-contact touch sensing.

### SUMMARY OF THE INVENTION

In view of the above demands, the inventors design a novel contactless touch panel after conducting elaborate research and with accumulated years of experience in this field.

It is an object of the present invention to provide a contactless touch panel for performing the touch-control operation with no need for contact with the touch panel.

It is an object of the present invention to provide a contactless touch panel in which miniaturized micro-sensors are arranged in a MEMS (micro electro mechanical systems) form.

It is an object of the present invention to provide a contactless touch panel in which multiple microsensors can be directly arranged by a current touch panel manufacturing process.

It is an object of the present invention to provide a contactless touch panel that senses the external touching object via an electric field or a magnetic field.

To achieve the foregoing objects, a contactless touch panel according to the present invention comprises a first transparent substrate, a plurality of microsensors, a second transparent substrate and a detecting element. The planar (or miniaturized) microsensors are arranged in an array or a matrix on a surface of the first transparent substrate. The second transparent substrate is adhered to and stacked on the first transparent substrate with an optically clear adhesive (OCA), so as to cover the microsensors. The detecting element is electrically connected to the microsensors for receiving sensing signals generated by the microsensors. Thus, when a preset touching object approaches (does not touch) the touch panel, the microsensors sense the touching object via an electric field or a magnetic field and generate sensing signals sent to the detecting element according to changes in the electric field or the magnetic field and their strength. The detecting element determines the position of the touching object above the touch panel to achieve the purpose of non-contact touch control.

### BRIEF DESCRIPTION OF THE DRAWINGS

FIG. 1 is a schematic view of a conventional contactless touch panel.

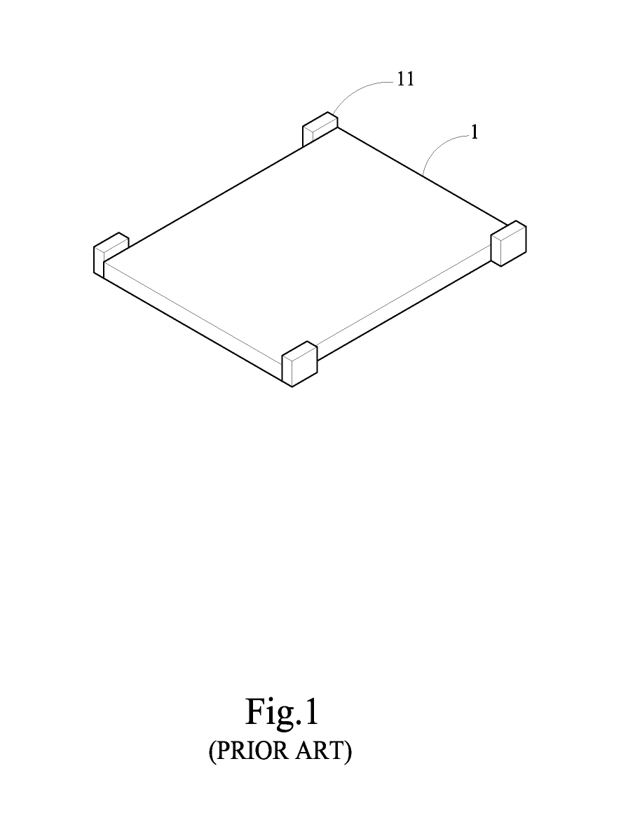

FIG. 2 is a three-dimensional exploded view of a preferred embodiment of the present invention.

FIG. 3A is a partial schematic view I of a preferred embodiment of the present invention.

FIG. 3B is a partial schematic view II of a preferred embodiment of the present invention.

FIG. 3C is a partial schematic view III of a preferred embodiment of the present invention.

FIG. 4A is a schematic view I showing the detection of a preferred embodiment of the present invention.

FIG. 4B is a schematic view II showing the detection of a preferred embodiment of the present invention.

FIG. 4C is a schematic view III showing the detection of a preferred embodiment of the present invention.

### DETAILED DESCRIPTION OF THE PREFERRED EMBODIMENTS

The contents of the present invention will become more apparent from the following description when taken in conjunction with the drawings.

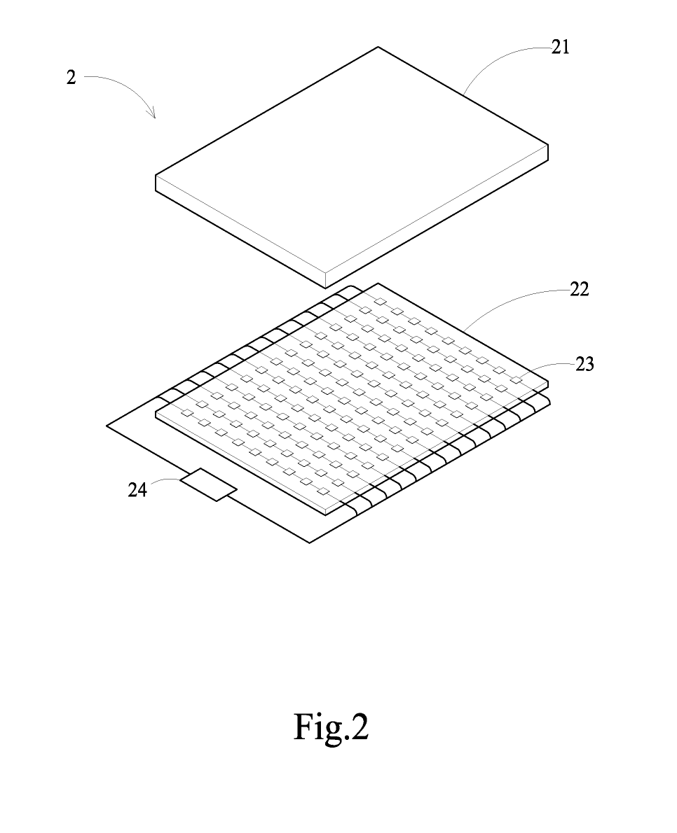

Referring to FIG. 2, there is shown a schematic view showing the structure of a preferred embodiment of the present invention. As shown in this figure, the contactless touch panel according to the present invention is a touch panel 2 and comprises a first transparent substrate 21, a second transparent substrate 22, a plurality of microsensors 23 and a detecting element 24.

The first transparent substrate 21 and the second transparent substrate 22 comprise a material selected from one of the group consisting of polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

The microsensors 23 are planar (or miniaturized) microsensors 23, which are arranged in a matrix or an array on a surface of the first transparent substrate 21. The second transparent substrate 22 is stacked on the first transparent substrate 21 to cover the microsensors 23. The second transparent substrate 22 and the first transparent substrate 21 are adhered to each other with an optically clear adhesive. It is to be supplemented with the further statement that, in actual production, the first transparent substrate 21 mentioned herein may be a cover lens/cover glass of a current liquid crystal display panel or touch panel, and the second transparent substrate 22 mentioned herein may be a optical sheet such as a polarization plate or a color filter within a current liquid crystal display panel, or an isolation layer within a touch panel.

The detecting element 24 is electrically connected to the microsensors 23 for receiving sensing signals generated by the microsensors 23.

It should be noted that the microsensors 23 are provided on the surface of the first transparent substrate 21 by mainly using impurity-doped oxides such as indium tin oxide (ITO), indium zinc oxide (IZO), Al-doped ZnO (AZO) and antimony tin oxide (ATO) as the material, or formed on the surface of the first transparent substrate 21 by sputtering or etching of carbon nanotubes. Otherwise, carbon nanotubes or impurity-doped oxides can be directly fabricated as the microsensors 23 and then adhered to the surface of the first transparent substrate 21 with an optically clear adhesive. X-directional and Y-directional sensing electrode films are arranged on a common touch panel through sputtering, etching or adhesion as described above. Therefore, the present invention can be implemented by a current touch panel manufacturing process, but the difference between a touch panel of the present invention and a conventional touch panel is that the microsensors 23 of the present invention serve as an independent sensing device and can directly sense an external touching object. However, the conventional touch panel requires physical contact to determine a position of a touch point through potential variations of the sensing electrode films, as specifically stated herein.

In addition to the arrangements as described above, the microsensors 23 may also be arranged in a MEMS form as miniaturized planar microsensors 23 with very small thicknesses. The microsensors 23 manufactured by a MEMS process may be coupled to the first transparent substrate 21 by sputtering, etching or adhesion.

Furthermore, when the microsensors 23 sense an external touching object, they can sense a position of the touching object above the surface of the touch panel 2 in a capacitive, inductive, electric-field or electro-magnetic manner. Moreover, the so-called electric-field or capacitive manner generally means that the strength or the magnitude of lines of magnetic force of an electric field or a magnetic field generated by a capacitive or inductive technique changes or the potential between the external object and the electric field or the magnetic field when the external touching object approaches the electric field or the magnetic field. Consequently, the microsensors 23 generate sensing signals transmitted to the detecting element 24 according to the above-mentioned changes. The detecting element 24 can determine a position of the external object (the touching object described in the present invention) above the touch panel 2 according to the sensing signals.

The touching object mentioned herein is not limited to a specific form. For example, a human finger, a common contact type touch pen, a writing implement, a presentation pointer pen (a baton) and the like are all included within the scope of the touching object of the invention.

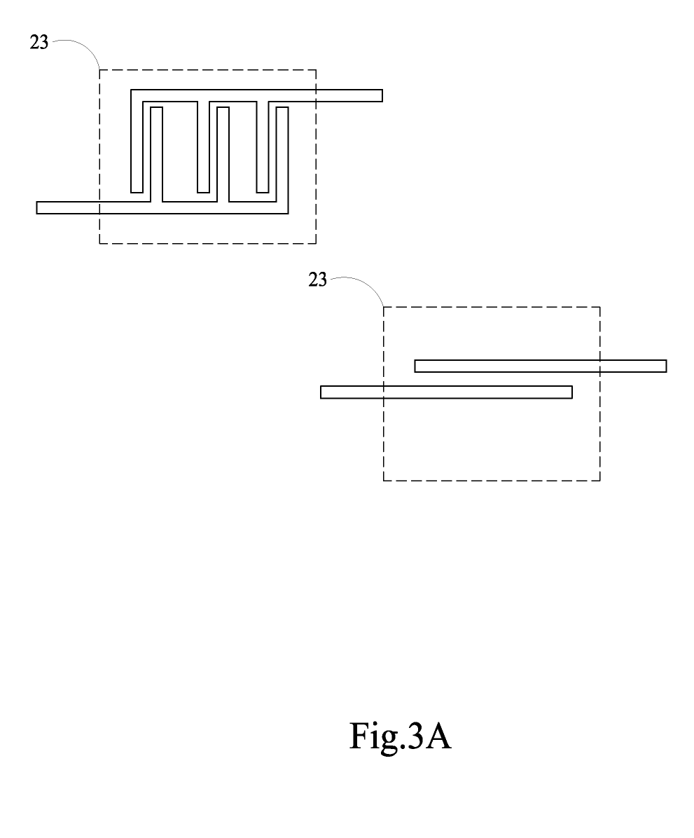

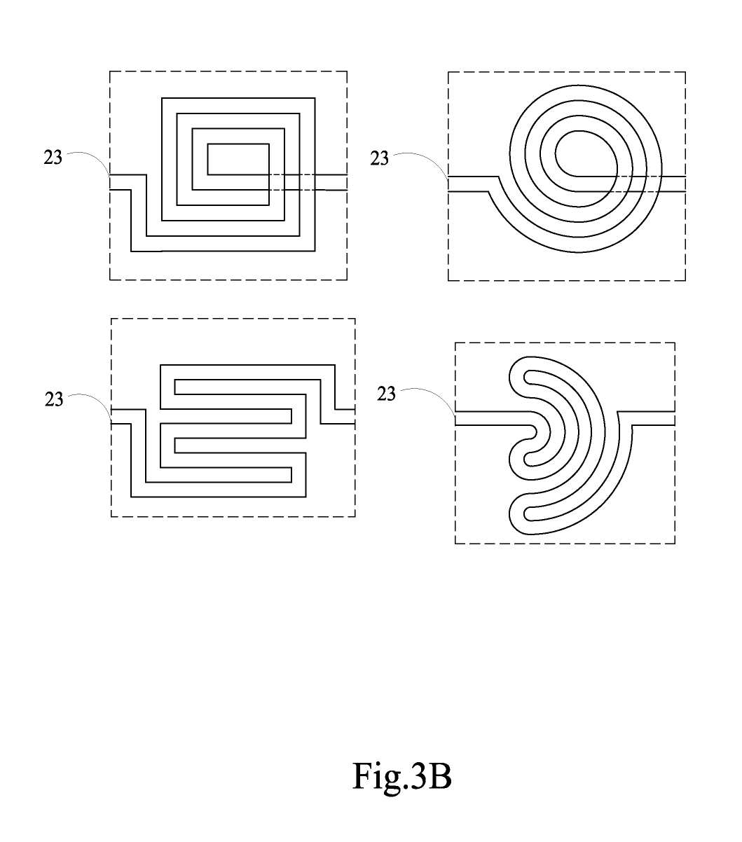

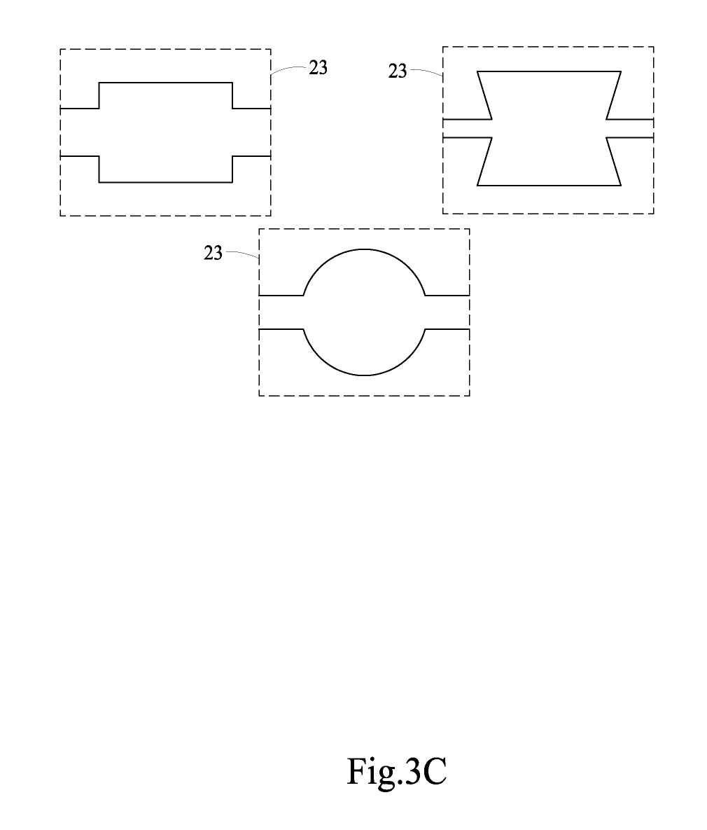

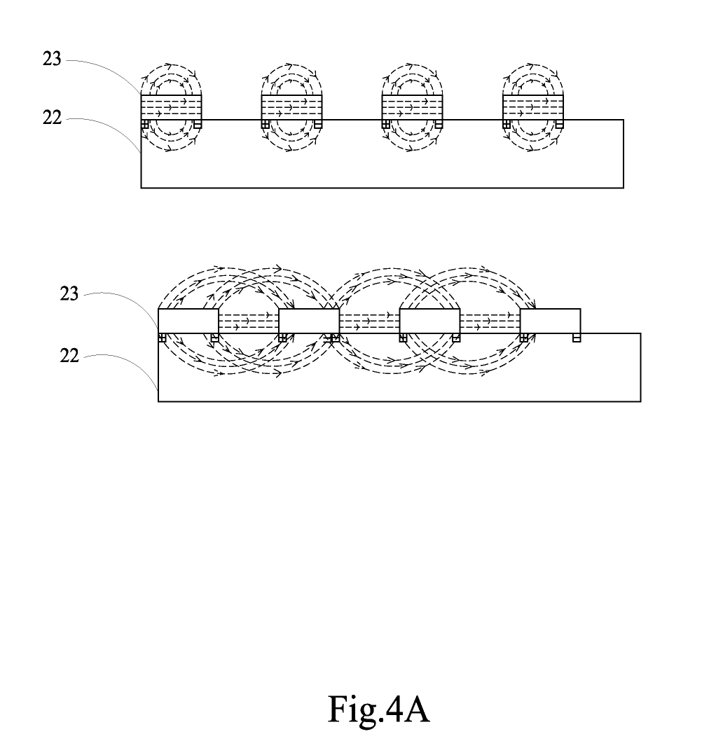

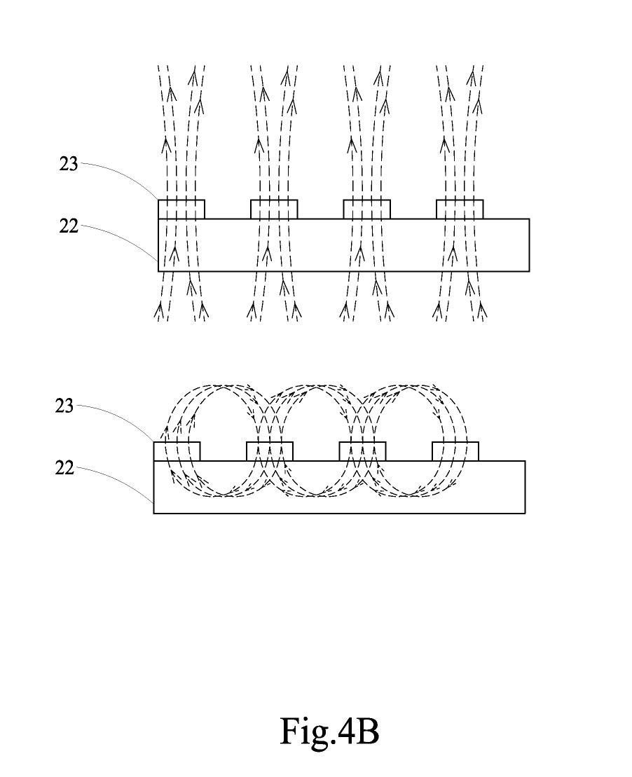

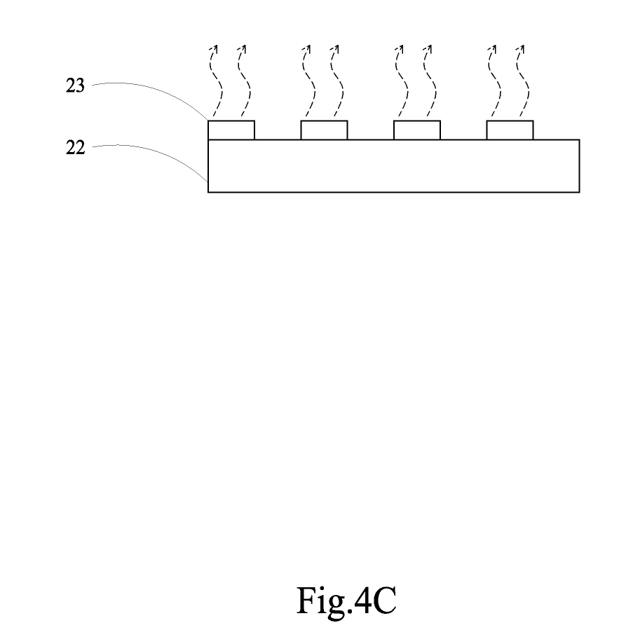

Referring to FIGS. 2, 3A and 4A, there are shown a schematic view showing the structure, a partial schematic view I and a schematic view I showing the detection of a preferred embodiment of the present invention. As shown in these figures, the microsensors 23 of the touch panel 2 are capacitive microsensors 23 in this embodiment, which are selected from one of the capacitive microsensor 23 group consisting of interdigital capacitors, planar capacitors and planar coupling capacitors.

In order to clearly differentiate the effects of self and mutual capacities in this embodiment, the self and mutual capacities are represented separately. Actually, when in action, both self and mutual capacities are present in the microsensors 23.

When a touching object approaches the sensing range of self or mutual capacities (or referred to as electro-magnetic and electric fields) of the microsensors 23, the touching object shields the capacitive field or varies the magnitude of the capacitive field. Therefore, the microsensors 23 can generate a corresponding sensing signal transmitted to the detecting element 24 according to the electric field variation. The detecting element 24 can calculate the distance from the touching object to the touch panel according to the magnitude of the electric field variation and simultaneously determine the position of the touching object above the touch panel 2 according to the position where the sensing signal is transmitted from the microsensors 23.

Referring to FIGS. 2, 3B and 4B, there are shown a schematic view showing the structure, a partial schematic view II and a schematic view II showing the detection of a preferred embodiment of the present invention. As shown in these figures, the microsensors 23 of the touch panel 2 are inductive microsensors 23 in this embodiment, which are selected from one of the inductive microsensor 23 group consisting of linear inductors, corrugated inductors, spiral inductors, folded inductors and arcuate folded inductors.

In order to clearly differentiate the effects of self and mutual inductances in this embodiment, the self and mutual inductances are represented separately. Actually, when in action, both self and mutual inductances are present in the microsensors 23.

When a touching object approaches the sensing range of self or mutual inductances (or referred to as electro-magnetic and electric fields) of the microsensors 23, the touching object shields the inductive field or varies the magnitude of the inductive or magnetic field. Therefore, the microsensors 23 can generate a corresponding sensing signal transmitted to the detecting element 24 according to the electric or magnetic field variation. The detecting element 24 can calculate the distance from the touching object to the touch panel according to the magnitude of the electric or magnetic field variation and simultaneously determine the position of the touching object above the touch panel 2 according to the position where the sensing signal is transmitted from the microsensors 23.

Referring to FIGS. 2, 3C and 4C, there are shown a schematic view showing the structure, a partial schematic view III and a schematic view III showing the detection of a preferred embodiment of the present invention. As shown in these figures, the microsensors 23 of the touch panel 2 are electromagnetic microsensors 23 in this embodiment, which are selected from one of the antenna-type microsensor 23 group consisting of rectangular antennas, circular antennas and bow-tie antennas.

In this embodiment, the antenna-type microsensors 23 continue to emit an electromagnetic field outwardly. When the touching object approaches the range of the electromagnetic field, the electromagnetic field, after contact with the touching object, is reflected, diffracted or refracted and then received by the microsensor 23 like the principle of the radar antenna. Therefore, the detecting element 24 can determine the position of the touching object according to the electromagnetic field signal sent back from the microsensors 23.

However, what are described above are only preferred embodiments of the invention and should not be used to limit the claims of the present invention; the above description can be understood and put into practice by those who are skilled in the present technical field, and therefore all equivalent changes and modifications made without departing from the spirit and scope of the present invention should be included in the appended claims.

In summarization of the foregoing description, the contactless touch panel according to the present invention meets the requirements of inventiveness and industrial applicability of patents. Therefore, the application for a patent is duly filed accordingly.

What is claimed is:

1. A contactless touch panel comprising:
a first transparent substrate;
a plurality of miniaturized planar microsensors arranged in an array on a surface of the first transparent substrate;
a second transparent substrate stacked on the first transparent substrate to cover the microsensors; and
a detecting element electrically connected to the microsensors for receiving sensing signals generated by the microsensors.

2. The contactless touch panel as described in claim 1, wherein the first transparent substrate and the second transparent substrate comprise a material selected from one of the group consisting of polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

3. The contactless touch panel as described in claim 1, wherein the first transparent substrate and the second transparent substrate are adhered to each other with an optically clear adhesive.

4. The contactless touch panel as described in claim 1, wherein the microsensors are arranged in a matrix or an array.

5. The contactless touch panel as described in claim 1, wherein the microsensor are miniaturized micro electro mechanical systems (MEMS) microsensors.

6. The contactless touch panel as described in claim 5, wherein the microsensors are formed on the surface of the first transparent substrate by sputtering, etching or adhesion.

7. The contactless touch panel as described in claim 1, wherein the microsensors are made of carbon nanotubes or impurity-doped oxides.

8. The contactless touch panel as described in claim 7, wherein the microsensors are formed on the surface of the first transparent substrate by sputtering, etching or adhesion.

9. The contactless touch panel as described in claim 7, wherein the impurity-doped oxide is selected from one of the impurity-doped oxides group consisting of indium tin oxide (ITO), indium zinc oxide (IZO), Al-doped ZnO (AZO) and antimony tin oxide (ATO).

10. The contactless touch panel as described in claim 1, wherein the microsensors are capacitive, inductive, electric-field or electromagnetic microsensors.

11. The contactless touch panel as described in claim 10, wherein the capacitive microsensors are selected from one of the capacitive microsensor group consisting of interdigital capacitors, planar capacitors and planar coupling capacitors.

12. The contactless touch panel as described in claim 10, wherein the inductive microsensors are selected from one of the inductive microsensor group consisting of linear inductors, corrugated inductors, spiral inductors, folded inductors and arcuate folded inductors.

13. The contactless touch panel as described in claim 10, wherein the electromagnetic microsensors are selected from one of the antenna-type microsensor group consisting of rectangular antennas, circular antennas and bow-tie antennas.
